(19) United States
(12) Patent Application Publication
(10) Pub. No.: US 2004/0105394 A1
(43) Pub. Date: Jun. 3, 2004

(54) System for end-to-end measurement of network information

(75) Inventors: Olivier Martinot, Draveil (FR); Stephane Betge-Brezetz, Paris (FR); Gerard Delegue, Cachan (FR); Emmanuel Marilly, Antony (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/704,673

(22) Filed: Nov. 12, 2003

(30) Foreign Application Priority Data
Nov. 28, 2002 (FR) 02 14 936

(51) Int. Cl. H04L 1/00

(52) U.S. Cl. 370/252

(57) ABSTRACT

The invention relates to measuring information within a telecommunication network. The information is measured by means of probes and then centralized at a measurement system. The measurement system then determines a measurement value as a function of the measurement information.

### CROSS-REFERENCE TO RELATED APPLICATIONS

This application is based on French Patent Application No. 02 14 936 filed Nov. 28, 2002, the disclosure of which is hereby incorporated by reference thereto in its entirety, and the priority of which is hereby claimed under 35 U.S.C. §119.

### BACKGROUND OF THE INVENTION

1. Field of the Invention

The present invention relates to the measurement of network information, in particular quality of service parameters.

2. Description of the Prior Art

Telecommunication networks can offer sophisticated telecommunication services, such as videoconferencing, voice over Internet protocol (VoIP), on-demand video, etc. These services necessitate conformance to various end-to-end quality of service parameters.

In particular, in a so-called “best effort” Internet Protocol (IP) network, conformance to these quality parameters is problematic, with the result that permanent monitoring is necessary, in order to verify that the quality of service parameters necessary for the telecommunication service are complied with at all times.

Similarly, the services provided on telecommunication networks are usually the subject of commercial negotiations between the telecommunication network operator, the service provider, and, where applicable, the clients of the service. The definition of the quality of service can enter into the negotiation, in the form of a service level agreement (SLA).

It is therefore necessary to provide information measuring mechanisms to be able to verify that each data flow conforms to the quality of service parameters at all times.

The expression “data flow” as used hereinafter refers to a set of packets conveying information belonging to the same multimedia session.

The Internet Engineering Task Force (IETF) is in the process of developing a solution described in the document “draft-ietf-ipfix=architecture-02.txt”, entitled “Architecture Model for IP Flow Information Export”, for example.

The mechanism described consists in disposing probes referred to as “IPFix Devices” in the network in order to observe the IP packets in transit. The information collected is then sent to measurement systems known as “collectors” in the form of aggregate information for each flow.

However, the above solution is silent on the operation and architecture of the measurement system.

The object of the invention is to propose a measurement system for obtaining measurement values from information collected by the probes. The measurement values can be used to verify conformance to negotiated quality of service parameters at all times, for example.

### SUMMARY OF THE INVENTION

To be more precise, the present invention consists in a measurement system including a receiver for receiving measurement information collected by a set of measurement probes connected to a telecommunication network and relating to packets of data in transit in the telecommunication network, a correlator for combining measurement information relating to the same data packet, and a calculator for determining a measurement value from the combined measurement information.

In one embodiment the correlator effects the combinations on the basis of a packet identifier contained in the measurement information and a time signature, also contained in the measurement information, associated with reception of the packet by each of the measurement probes.

In one embodiment the measurement value is of any type from the following list:

loss of packets,

end-to-end transmission time,

transmission time variation,

bit rate or bandwidth used for the data flow or flows to which the packets belong,

retransmission error rate.

In one embodiment the measurement value is stored in a database.

In one embodiment the receiver is adapted to read a serial number contained in the measurement information and to bring about resending in the event of missing measurement information.

The invention also provides an end-to-end measurement method including a step for collecting measurement information relating to packets of data in transit on a telecommunication network from a set of measurement probes connected to the telecommunication network, a correlation step for combining measurement information relating to the same data packet, and a calculation step for determining a measurement value from the combined measurement information.

The invention and its advantages become more clearly apparent in the course of the following description with reference to the appended drawings.

### BRIEF DESCRIPTION OF THE DRAWINGS

FIG. 1 shows the functional architecture of a measurement system and its context.

FIG. 2 is a diagram of an IPv4 (Internet protocol—version 4) data packet.

### DETAILED DESCRIPTION OF THE PREFERRED EMBODIMENT

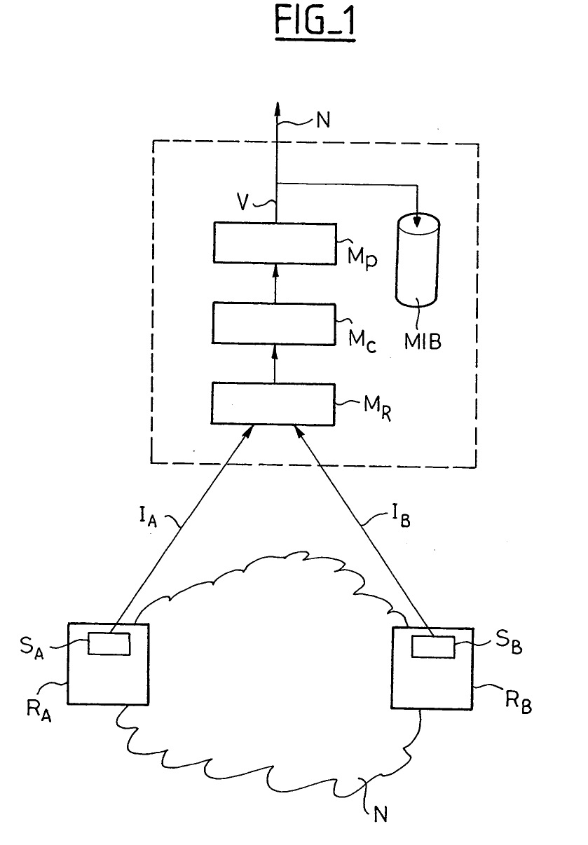

In the example shown in FIG. 1, two measurement probes SA and SB are connected to a telecommunication network N.

The measurement probes can be separate devices, in which case they must be physically connected to the telecommunication network, like any other network element.

Another option is to integrate the measurement probes into network elements R_{A}, R_{B} already installed. The measurement probes can then be software modules that are downloaded to the network elements, for example, or already installed and configured.

The purpose of the measurement probes is to collect measurement information relating to data packets passing through them or through the network elements on which they are implemented.

In one embodiment of the invention, the measurement probes can have:

filtering capabilities, in order to select packets corresponding to certain criteria, for example those that belong to a given flow or set of flows,

sampling capabilities, in order to select packets only in accordance with a time criterion (one every n milliseconds) or a space criterion (one in n packets).

The measurement probes can additionally have an interface for configuring them (setting parameters of the time or space criteria, for example, or setting parameters of filter criteria, etc.).

When a packet passes through the network element R_{A} and then, after crossing the network N, the network element R_{B}, the probes S_{A} and S_{B} respectively collect network information I_{A} and I_{B} relating to the same packet.

The measurement information contains at least an identifier of the packet and a time signature associated with reception of the packet by each of the measurement probes.

Accordingly, the probe S_{A} collects an identifier of the packet received and determines a time signature, for example the time T_{A} at which the packet was received. This data is inserted into the measurement information I_{A} that is then sent to the measurement system M.

Similarly, when the probe S_{B} receives the packet, it collects an identifier of the packet and determines a time signature, for example the time T_{B} at which the packet was received. As previously, this data is inserted into the measurement information I_{B} and sent to the measurement system M.

The reception times T_{A} and T_{B} can be determined by internal clocks of the network elements. If the measurement probes are separate devices, they can incorporate the internal clocks themselves.

The clocks can be synchronized with each other. This is known in the art. Synchronization can be effected by means of the Global Positioning System (GPS) and/or a synchronization protocol such as the Network Time Protocol (NTP), which is described on the web site http:/www.ntp.org, for example.

The packet identifier can take various forms.

In one embodiment of the invention, this identifier contains an n-tuple taken from fields of the header of the received packet.

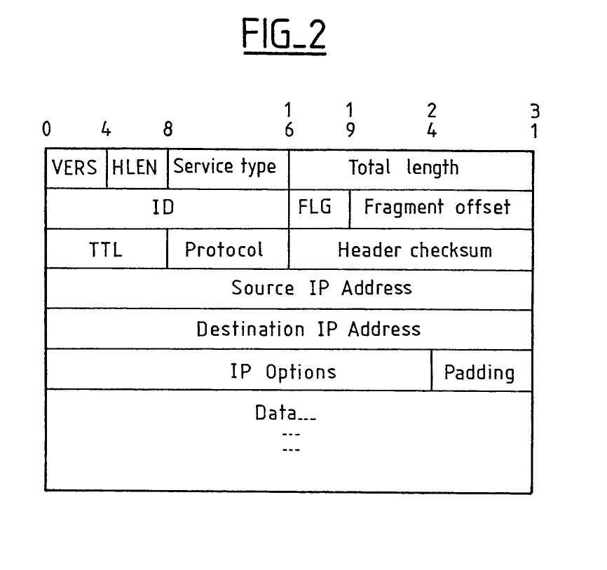

FIG. 2 is a diagram representing a received packet conforming to the Internet Protocol—version 4 (IPv4). Of course, the person skilled in the art can adapt the invention to take account of other protocols, in particular the Internet Protocol—version 6 (IPv6).

A packet of this kind consists of a header H and a payload P containing higher level data conveyed by the packet. The header H is itself made up of several fields, the usual names of which are indicated in the figure. The tabular presentation of FIG. 2 is also standard, and conforms to the usual publications of the person skilled in the art. In particular, the table is 32 bits wide and is read from left to right, starting at the top of the table, at the “VERS” field.

The composition of an IP packet is described in “TCP/IP Tutorial and Technical Overview”, published by IBM, for example.

In one embodiment, identifying a packet unambiguously amounts to identifying that it belongs to a given source/destination pair and then verifying the “identification” field.

The identifier can then be constructed from the following fields:

“ID” or “Identification”.

“Source IP address”.

“Destination IP address”.

The “ID” field is an identification field whose value is determined by the sender of the packet. If a packet is fragmented by a router, the resulting packets retain the same value in the “ID” field. This field can therefore identify fragmented packets belonging to the same original packet.

The “Source IP address” and “Destination IP address” fields respectively represent the addresses of the terminals (hosts) sending and receiving the packet, coded on 32 bits.

Other fields can be used instead of or in addition to some or all of the fields previously referred to.

Another option for constructing the identifier is to calculate a unique “checksum” value from a plurality of fields of the header of the packet, or even the data itself, or other compression algorithms.

As previously stated, the indicator and the time signature form the measurement information I_{A}, I_{B} that the measurement probes S_{A}, S_{B} send to the measurement system M.

The protocol used for this can be based on the User Datagram Protocol (UDP), for example. In one embodiment, a security protocol can be used to prevent interception of the information by a third party or insertion of erroneous information by a third party. If the measurement information is finally used to invoice for use of the telecommunication network by customers, it is crucial for the measurement information to be correct. This relies on securing the transmission protocol.

The measurement system M includes a receiver MR whose object is to receive measurement information sent by the measurement probes.

In one embodiment of the invention, the receiver MR is also adapted to read a serial number inserted into the measurement information by the measurement probes. In this embodiment, the measurement probes SA, SB number each of the packets containing measurement information that they send to the measurement system M. The latter can then easily verify that no packets are missing on reception.

If a packet containing measurement information goes missing, the measurement system M can cause it to be sent again, for example by sending the measurement probe concerned a resending request containing the number of the missing packet. In this embodiment, the measurement probes can store measurement information in order to be able to resend it at the request of the measurement system M. All of the information can be stored in memory, or only part of it. In the latter case, the memory functions as a buffer memory: the most recent information replaces the least recent information.

In another embodiment, the receiver can simply ignore the lost packet. A counter associated with the measurement probe S_{A}, S_{B} can then be incremented.

Within the measurement system M, the measurement information I_{A}, I_{B} is then sent from the receiver M_{R} to a correlator M_{C}.

The role of the correlator M_{C} is to combine the measurement information relating to the same data packet. To this end, the correlator M_{C} preferably uses the packet identifier contained in the measurement information received.

By comparing the identifiers contained in each measurement information packet received, the correlator determines, if two identifiers contained in two measurement information packets are equal, that the measurement information relates to the same data packet transmitted over the telecommunication network.

Accordingly, in the FIG. 1 example, the same data packet passing through the network element R_{A} toward the network element R_{B} causes the probes S_{A} and S_{B} to send two measurement information packets I_{A} and I_{B} containing the same packet identifier. The receiver M_{R} and then the correlator M_{C} receive the measurement information. The correlator then combines the measurement information I_{A} and the measurement information I_{B} because they contain the same packet identifier.

Evidently, the number of items of measurement information to be combined can be greater than 2, if the number of measurement probes is greater than 2.

In one embodiment, the correlator can use a clock to count the time elapsed on receiving measurement information that has not yet been combined. If it has not been possible to combine further measurement information with first measurement information at the end of a certain time period, this may signify that the corresponding data packet has been lost within the network N. A mechanism can be started, for example a mechanism that simply sends non-combined measurement information to the calculator M_{P}.

Because a transmission monitoring mechanism is used between the measurement probes and the receiver, failure to receive further measurement information is indicative of a loss of packets.

After combination by the correlator M_{C} (or without combination in the event of loss of a packet), the calculator M_{P} continues to process the measurement information.

The role of the calculator M_{P} is to determine one or more measurement values V from the measurement information I_{A}, I_{B}.

The measurement value can be any type from the following list:

loss of data packets,

end-to-end transmission time,

transmission time variation,

bit rate or bandwidth used,

retransmission error rate.

The above list is provided by way of illustration and is in no way comprehensive.

The value V can be calculated for a given data flow, for all the data flows passing through the measurement probes, etc.

The data flow to which a data packet belongs can be determined in various ways that will be evident to the person skilled in the art.

For example, the information carried by the identifiers contained in the measurement information I_{A}, I_{B} can also be used to determine the flow to which the data packet belongs.

The following fields can typically be used to determine the flow:

“Source IP address”.

“Destination IP address”.

“Protocol”.

The “Protocol” field represents the higher level protocol corresponding to the data transmitted by the packet. This field is coded on 8 bits. For example, a value of 6 represents the Transmission Control Protocol (TCP), a value of 17 represents the User Datagram Protocol (UDP), and a value of 89 represents the Open Shortest Path First (OSPF) protocol used to calculate routing paths within the network.

Other parameters can be used in addition to or instead of some or all of the above fields.

The differentiated service code point (DSCP) field can be used, for example. The DSCP is a value, usually referred to as the “color”, indicating a differentiated quality of service for the data flow to which the packet belongs. It enables the network elements to give priority to processing and routing packets having a higher priority DSCP value. The DSCP value is inserted in the “Service Type” field.

The specifications relating to this value are described in RFC 2474 of the Internet Engineering Task Force (IETF), for example, which is entitled “Definition of the Differentiated Services Field (DS Field) in the IPv4 and IPv6 headers”, by K. Nichols, S. Blaker, F. Baker and D. Black, published in December 1998.

Information relating to the higher level protocols (TCP, UDP, etc.) can also be used.

Similarly, rather than determining the measurement value V on the basis of an individual flow, it can be calculated for an aggregate of flows, i.e. for all the flows having the same IP source and destination addresses.

In which case, only the “Source IP address” and “Destination IP address” fields can be used.

Moreover, calculating the measurement value V can be limited to a measurement range. For example, the calculator M_{P} calculates the measurement value V periodically and as a function of measurement information received in a measurement interval corresponding to the period. This enables the behavior of the measurement value V to be tracked over time.

The calculator M_{P} can calculate the loss of data packets from measurement information that has not been combined by the correlator M_{C}. Accordingly, on receiving non-combined measurement information, a counter can be incremented giving the number of packets lost, and in this case the value V is the number of packets lost.

It may also be beneficial for the measurement value V to be the ratio between the number of packets lost and the total number of packets. In this case, two counters are needed: one is incremented each time non-combined measurement information is received and the other is incremented each time measurement information is received, whether it is combined or not.

The transmission time can be calculated for each data packet sent via the telecommunication network N. As previously explained, each data packet leads to the combination of the measurement information I_{A} and the measurement information I_{B} by the correlator M_{C}. The measurement information contains a time signature characteristic of the time at which the data packet was received or processed by the measurement probe. Given the clocks associated with the measurement probes S_{A}, S_{B}, the transmission time between the two probes S_{A} and S_{B} can be calculated as the difference between the time signature values. In this example, the measurement value V can simply be this difference value.

As previously mentioned, the measurements can be repeated over time, preferably periodically. It is then possible to calculate the behavior of the measurement values, and in particular to determine the variation of the transmission time.

To do this, the values of the transmission time calculated by the calculator M_{P} must be stored by the measurement system M. The calculator M_{P} can calculate the variation from the stored values in various ways that are known to the person skilled in the art.

One simple way is to calculate the time variation between two consecutive packets of the same flow of packets.

Similarly, the measurement information can be used to determine the bit rate or the bandwidth used between two points. To do this, the measurement information I_{A}, I_{B} further contains the size of the packet.

Accordingly, by summing the sizes of the packets, the total volume of data transmitted is obtained. It is easy to determine this value for a given flow or a given aggregate of flows.

If a data packet in transit between two network elements is retransmitted between those two network elements, the packet may appear one too many times in the list of outgoing data packets. Each surplus data packet corresponds to an error in the flow to which it belongs.

When the measurements are calculated, they can be sent to network management applications in the form of notifications N. In another embodiment, they can be stored in a Management Information Base (MIB). The MIB can be consulted by network management applications using a network management protocol such as the Simple Network Management Protocol (SNMP), Common Management Information Protocol (CMIP), etc.

The measurement system M can be a central unit or distributed, for example over a set of servers or processes. For example, to obtain this distribution feature, the measurement system M can be based on a Common Object Request Broker (CORBA) software platform as specified by the Open Management Group (OMG).

For example, the constituent processes of the measurement system M can be organized:

in functional form: the receiver M_{R}, correlator M_{C}, and calculator M_{P} can then each form an independent process;

for the purposes of load distribution: the receiver M_{R}, correlator M_{C}, and calculator M_{B} can be subdivided into different processes, for example each in charge of a group of flows of packets (depending on the type of content, for example).

In one embodiment, the measurement systems M or some of them can be included in the network elements themselves.

The measurement systems can additionally include an interface for configuring them. In one embodiment, configuration can be carried out during operation, without disturbing the measurement process.

There is claimed:

1. A measurement system including a receiver for receiving measurement information collected by a set of measurement probes connected to a telecommunication network and relating to packets of data in transit in said telecommunication network, a correlator for combining measurement information relating to the same data packet, and a calculator for determining a measurement value from said combined measurement information.

2. The measurement system claimed in claim 1, wherein said correlator effects said combinations on the basis of a packet identifier contained in said measurement information and a time signature, also contained in said measurement information, associated with reception of said packet by each of said measurement probes.

3. The measurement system claimed in claim 1, wherein said measurement value is of any type from the following list:
loss of packets,
end-to-end transmission time,
transmission time variation,
bit rate or bandwidth used for the data flow or flows to which said packets belong,
retransmission error rate.

4. The measurement system claimed in claim 1 wherein said measurement value is stored in a database.

5. The measurement system claimed in claim 1 wherein said receiver is adapted to read a serial number contained in said measurement information and to bring about resending in the event of missing measurement information.

6. The measurement system claimed in claim 1 further including a configuration interface.

7. An end-to-end measurement method including a step for collecting measurement information relating to packets of data in transit on a telecommunication network from a set of measurement probes connected to said telecommunication network, a correlation step for combining measurement information relating to the same data packet, and a calculation step for determining a measurement value from said combined measurement information.
